(19) United States
(12) Patent Application Publication
(10) Pub. No.: US 2024/0372073 A1
(43) Pub. Date: Nov. 7, 2024

(54) FEEDSTOCKS AND METHODS FOR FABRICATION OF IRON ELECTRODES USING SULFIDE-CONTAINING PARTICLES

(71) Applicant: FORM ENERGY, INC., Somerville, MA (US)

(72) Inventors: Michael Andrew GIBSON, Philadelphia, PA (US); Nicholas Reed PERKINS, Somerville, MA (US); Leah Nicole NATION, Cambridge, MA (US); Joseph Stephen MANSER, Lowell, MA (US); Zachariah NORMAN, Lincoln, MA (US); Annelise Christine THOMPSON, Medford, MA (US)

(21) Appl. No.: 18/435,597

(22) Filed: Feb. 7, 2024

Related U.S. Application Data
(60) Provisional application No. 63/483,691, filed on Feb. 7, 2023.

(51) Int. Cl. H01M 4/36; H01M 4/04; H01M 4/38

(52) U.S. Cl. CPC H01M 4/364; H01M 4/0407; H01M 4/366; H01M 4/38

(57) ABSTRACT

According to one aspect, a feedstock for fabricating an iron electrode of an electrochemical cell may include iron-containing particles of a first material, sulfide-containing particles of a second material different from the first material, and a barrier material different from each of the first material and the second material, the barrier material at least partially physically separating the sulfide-containing particles from the iron particles, the at least partial physical separation of the iron-containing particles from the sulfide-containing particles maintainable by the barrier material at temperatures at which iron in the iron-containing particles bonds in the solid state.

### CROSS-REFERENCE TO RELATED APPLICATIONS

This application claims the benefit of priority to U.S. Provisional Patent Application 63/483,691, filed Feb. 7, 2023, with the entire contents of each of these applications hereby incorporated herein by reference.

### BACKGROUND

Energy storage technologies are playing an increasingly important role in electric power grids. These energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, >8 h) energy storage systems.

Iron-based negative-electrode electrochemical systems (or said another way, iron-based-anode electrochemical systems) are attractive options for electrochemical energy storage. However, there exists a need to improve the design and composition of electrochemical systems having iron-based materials, such as iron-based negative electrodes, to enhance the performance of such systems.

### SUMMARY

According to one aspect, a feedstock for fabricating an iron electrode of an electrochemical cell may include iron-containing particles of a first material, sulfide-containing particles of a second material different from the first material, and a barrier material different from each of the first material and the second material, the barrier material at least partially physically separating the sulfide-containing particles from the iron-containing particles, the at least partial physical separation of the iron-containing particles from the sulfide-containing particles maintainable by the barrier material at temperatures at which iron in the iron-containing particles bonds in the solid state.

In some implementations, the second material of the sulfide-containing particles may include any one or more of iron sulfide, tin sulfide (SnS), bismuth sulfide (Bi₂S₃), aluminum sulfide (Al₂S₃), antimony (III) sulfide (Sb₂S₃), antimony (V) sulfide (Sb₂S₅), manganese sulfide (MnS), iron disulfide (FeS₂), iron-copper sulfide, cadmium sulfide (CdS), silver sulfide (AgS), titanium disulfide (TiS₂), lead sulfide (PbS), nickel sulfide (NiS), antimony sulfide (Sb₂S₃), copper sulfide (CuS, Cu2S), cobalt sulfide (CoS), tungsten sulfide (WS₂), molybdenum sulfide (MoS₂), manganese sulfide (MnS), sodium sulfide (Na₂S), nickel sulfide (Ni₃S₂), indium sulfide (In₂S₃), zinc sulfide (ZnS), or a combination thereof.

In certain implementations, the barrier material may include at least one oxide. As an example, the at least one oxide may include alumina (Al2O₃), magnesium oxide (MgO), calcium oxide (CaO), silica (SiO₂), zinc oxide (ZnO), zirconium oxide (ZrO₂), one or more iron oxide, or a combination thereof.

In some implementations, the barrier material may include one or more carbides. For example, the one or more carbides may include silicon carbide (SiC), tungsten carbide (WC), hafnium carbide (HfC), zirconium carbide (ZrC), titanium carbide (TIC), iron carbide (FeC), or a combination thereof.

In certain implementations, the barrier material may include one or more silicides. As an example, the one or more silicides includes molybdenum silicide (MoSi2), one or more iron silicide, or a combination thereof.

In some implementations, the barrier material may include one or more sulfide-based materials. For example, the one or more sulfide-based materials may include iron sulfide (FeS), copper (I) sulfide (Cu₂S), tungsten disulfide (WS₂), or a combination thereof.

In certain implementations, the barrier material may include one or more carbon-based materials. As an example, the one or more carbon-based materials may include graphite, amorphous carbon, soot, or a combination thereof.

In some implementations, the barrier material may be soluble in an electrolyte.

In certain implementations, the barrier material may be porous.

In some implementations, the barrier material may be nonporous.

In certain implementations, a mean particle size of the sulfide-containing particles is from 1 micron to 1000 microns.

In some implementations, the barrier material may be a coating on the iron-containing particles, on the sulfide-containing particles, or on a combination thereof. As an example, the coating of the barrier material may have an average thickness less than a mean particle size of the iron-containing particles, less than a mean particle size of the sulfide-containing particles, or both. As a more specific example, the average thickness of the coating of the barrier material may be less than 40% of at least one of the mean particle size of the iron-containing particles or the mean particle size of the sulfide-containing particles. Further, or instead, the coating of the barrier material may have an average thickness of about 0.1 angstroms to about 10 nanometers. Additionally, or alternatively, the coating of the barrier material may at least partially covers respective outer surfaces of the iron-containing particles, respective outer surfaces of the sulfide-containing particles, or a combination thereof. Still further, or instead, the coating of the barrier material may be discontinuous such that the coating defines one or more gaps on of the respective outer surfaces of the iron-containing particles, on the respective outer surfaces of the sulfide-containing particles, or a combination thereof. In some implementations, the coating of the barrier material may envelop the respective outer surfaces of the iron-containing particles, the sulfide-containing particles, or both.

In certain implementations, the barrier material may be flowable relative to the iron-containing particles, relative to the sulfide-containing particles, or both.

In some implementations, the iron-containing particles may be porous.

In certain implementations, the iron-containing particles may include metallic iron, iron oxide, iron hydroxide, iron sulfide, iron silicide, iron carbide, or a combination thereof.

In some implementations, the iron-containing particles may include sponge iron powder. For example, the sponge iron powder may include direct reduced iron (DRI) particles.

In certain implementations, the iron-containing particles may include atomized iron powder.

In some implementations, the iron-containing particles may be in powder form.

In certain implementations, the sulfide-containing particles may be in powder form.

According to another aspect, a method of fabricating an iron electrode for an electrochemical cell may include forming a feedstock including a barrier material, iron-containing particles of a first material, and sulfide-containing particles of a second material, the barrier material at least partially physically separating the sulfide-containing particles from the iron-containing particles in the feedstock, and the first material, the second material, and the barrier material each differing from one another, and bonding iron in the iron-containing particles in the solid state via thermal processing as the barrier material at least partially maintains physical separation of the iron-containing particles from the sulfide-containing particles.

In certain implementations, forming the feedstock may include creating a coating of the barrier material on the iron-containing particles, on the sulfide-containing particles, or on a combination thereof. For example, creating the coating may include a solid-phase coating process. As a specific example, the solid-phase coating process may include physically abrading the barrier material against the iron-containing particles and/or against the sulfide-containing particles. Further, or instead, creating the coating may include a gas-phase coating process. For example, the gas-phase coating process may include powder atomic layer deposition of the barrier material. Additionally, or alternatively, the gas-phase coating process may include chemical vapor deposition of the barrier material. Further, or instead, creating the coating may include a liquid-phase coating process. As a specific example, the liquid-phase coating process may include at least partially covering the iron-containing particles and/or the sulfide-containing particles with a slurry including the barrier material. Still further, or instead, creating the coating of the barrier material may include chemical precipitation of the barrier material from a solution. Additionally, or alternatively, creating the coating of the barrier material may include at least partially covering the iron-containing particles, the sulfide-containing particles, or a combination thereof with a precursor material and processing the precursor material into the barrier material. As an example, the precursor material may include a carbon-based material, and processing the precursor material into the barrier material includes pyrolyzing the carbon-based material. In certain instances, forming the feedstock may include forming the sulfide-containing particles from a metallic precursor and a sulfur precursor such that the sulfide-containing particles are nanoparticles. For example, the metallic precursor may be zinc carboxylate. Further, or instead, the sulfur precursor may be sodium sulfide (Na₂S), thiourea, or a combination thereof. Additionally, or alternatively, formation of the metallic precursor and the sulfur precursor into the sulfide-containing particles may be carried out in a pressure vessel containing water at 125° C. Still further, or instead, formation of the metallic precursor and the sulfur precursor into the sulfide-containing particles is carried out in an organic solvent. In some instances, the coating of the barrier material may include iron oxide coated on the iron-containing particles. In certain instances, the barrier material may include an oxide and creating the coating of the barrier material includes oxidizing the sulfide-containing particles to form a layer of oxide on the sulfide-containing particles. For example, the barrier material may include zinc oxide (ZnO), the sulfide-containing particles include zinc sulfide (ZnS), and creating the coating of the barrier material includes oxidizing the ZnS to form a layer of ZnO on the zinc sulfide of the sulfide-containing particles. Further, or instead, the sulfide-containing particles may be oxidized in a fluidized bed.

In some implementations, forming the feedstock may include producing the barrier material from one or more impurities in the sulfide-containing particles. For example, the one or more impurities may include aluminum, and producing the barrier material includes oxidizing the aluminum to form alumina (Al2O₃).

In certain implementations, the barrier material may include iron sulfide (FeS), and forming the feedstock includes reacting sulfide-containing particles with iron of the iron-containing particles to form FeS of the barrier material.

In some implementations, bonding iron in the iron-containing particles in the solid state via thermal processing of the feedstock may include sintering the feedstock, hot pressing the feedstock, or a combination thereof.

In certain implementations, bonding iron in the iron-containing particles in the solid state via thermal processing is carried out at temperatures greater than 600° C. and less than about 1200° C.

In some implementations, bonding iron in the iron-containing particles in the solid state via thermal processing may be carried out in a gaseous environment. For example, the gaseous environment may include hydrogen, carbon monoxide gas, or a combination thereof. Further, or instead, the gaseous environment may include one or more inert gases. For example, the one or more inert gases may include nitrogen, argon, or a combination thereof.

In certain implementations, bonding iron in the iron-containing particles in the solid state via thermal processing may be carried out in a vacuum environment.

According to yet another aspect, an iron electrode may be formed by any one or more of the foregoing methods.

### DESCRIPTION OF THE DRAWINGS

FIG. 1A is a schematic of an iron-air electrochemical cell including an iron electrode.

FIG. 1B is a schematic representation of a portion of a feedstock for fabricating the iron electrode of the iron-air electrochemical cell of FIG. 1A, the feedstock including iron-containing particles and sulfide-containing particles contacting one another such that a reduction reaction occurs between iron in the iron-containing material and sulfur in the sulfide-containing material.

FIG. 2A is a schematic representation of a portion of a feedstock for fabricating the iron electrode of the iron-air electrochemical cell of FIG. 1A, the feedstock including iron-containing particles, sulfide-containing particles, and a barrier material, with the barrier material coated on the sulfide-containing particles to at least partially physically separate the sulfide-containing particles from the iron-containing particles.

FIG. 2B is a schematic representation of a portion of a feedstock for fabricating the iron electrode of the iron-air electrochemical cell of FIG. 1A, the feedstock including iron-containing particles, sulfide-containing particles, and a barrier material, with the barrier material coated on the iron-containing particles to at least partially physically separate the sulfide-containing particles from the iron-containing particles.

FIG. 2C is a schematic representation of a portion of a feedstock for fabricating the iron electrode of the iron-air electrochemical cell of FIG. 1A, the feedstock including iron-containing particles, sulfide-containing particles, and a barrier material, with the barrier material coated on the sulfide-containing particles and on the iron-containing particles to at least partially physically separate the sulfide-containing particles from the iron-containing particles.

FIG. 3A is a schematic representation of a portion of a feedstock for fabricating the iron electrode of the iron-air electrochemical cell of FIG. 1A, the feedstock including iron-containing particles, sulfide-containing particles, and a barrier material, with the barrier material partially covering the sulfide-containing particles to at least partially physically separate the sulfide-containing particles from the iron-containing particles.

FIG. 3B is a schematic representation of a portion of a feedstock for fabricating the iron electrode of the iron-air electrochemical cell of FIG. 1A, the feedstock including iron-containing particles, sulfide-containing particles, and a barrier material, with the barrier material partially covering the iron-containing particles to at least partially physically separate the sulfide-containing particles from the iron-containing particles.

FIG. 3C is a schematic representation of a portion of a feedstock for fabricating the iron electrode of the iron-air electrochemical cell of FIG. 1A, the feedstock including iron-containing particles, sulfide-containing particles, and a barrier material, with the barrier material partially covering the iron-containing particles and partially covering the sulfide-containing particles to at least partially physically separate the sulfide-containing particles from the iron-containing particles.

FIG. 4 is a flowchart of an exemplary method of fabricating an iron electrode for an iron-air electrochemical cell.

FIG. 5 is an Ellingham diagram showing stability of various sulfides through comparing free energy changes during formation of the various sulfides.

FIG. 6A is a schematic representation of a fully coated particle.

FIG. 6B is a cross-section of the fully coated particle of FIG. 6A.

FIG. 7A is a schematic representation of a partially coated particle.

FIG. 7B is a cross-section of the particle of FIG. 7A.

Like reference symbols in the various drawings indicate like elements.

### DETAILED DESCRIPTION

Embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the disclosure is not intended to limit the disclosure to these embodiments but rather to enable a person skilled in the art to make and use this disclosure. Unless otherwise noted, the accompanying drawings are not drawn to scale.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The various embodiments of systems, equipment, techniques, methods, activities, and operations set forth in this specification may be used for various other activities and in other fields in addition to those set forth herein. Additionally, these embodiments, for example, may be used with other equipment or activities that may be developed in the future and with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other. Thus, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. The scope of protection afforded the present disclosure should not be limited to a particular embodiment, configuration or arrangement that is set forth in a particular embodiment, example, or in an embodiment in a particular figure.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Embodiments of the present disclosure include apparatuses, systems, and methods for long-duration, and ultra-long-duration energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage devices or systems may refer to energy storage devices or systems that may be configured to store energy over time spans of days, weeks, or seasons. For example, the energy storage devices or systems may be configured to store energy generated by solar cells during the summer months, when sunshine is plentiful and solar power generation exceeds power grid requirements, and discharge the stored energy during the winter months, when sunshine may be insufficient to satisfy power grid requirements.

According to other embodiments, the present disclosure includes apparatus, systems, and methods for energy storage at shorter durations of less than about 8 hours. For example, the electrochemical cells may be configured to store energy generated by solar cells during the diurnal cycle, where the solar power generation in the middle of the day may exceed power grid requirements, and discharge the stored energy during the evening hours, when the sunshine may be insufficient to satisfy power grid requirements. As another example, said invention may include energy storage used as backup power when the electricity supplied by the power grid is insufficient, for installations including homes, commercial buildings, factories, hospitals, or data centers, where the required discharge duration may vary from a few minutes to several days.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal resistive elements in series. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electric current and ionic current flowing in the opposite direction as that of a discharging battery in service.

Metal-air batteries are electrochemical cells that include a metal anode, a cathode that is exposed to air, and an aqueous or aprotic electrolyte. During discharging of a metal-air battery, a reduction reaction may occur in the cathode and the metal anode is oxidized.

Iron-air batteries may provide grid-scale energy storage. In addition, the main raw material of iron-air batteries is iron oxide, which is an abundant, inexpensive, non-toxic, and economical material. Half-cell reactions on an iron anode that occur during discharge and oxidation in an alkaline electrolyte include: step 1) Fe+2OH-⇄Fe(OH)₂+2e⁻; and step 2) 3Fe(OH)₂+2OH—Fe₃O₄+4H2O+2e⁻. Other discharge reactions may be possible to form, for example, FeOOH or Fe₂O₃ as discharge products.

Iron (Fe) electrodes, such as iron (Fe) anodes in iron-air batteries, may include a sulfide-containing additive for reducing undesirable side reactions when processing iron-containing material into iron electrodes at elevated temperatures. The present disclosure provides a solution to reduce, minimize, and/or prevent the evaporation of the sulfide-containing additive from an iron (Fe) anode in which sulfide-containing additive is used during fabrication (e.g., high temperature processing) of the iron electrode. According to various embodiments of the present disclosure, a method of at least partially physically separating separating sulfide-containing particles and iron-containing particles from each other during fabrication of the iron electrode may be implemented to reduce, or eliminate, contact of the sulfide-containing particles with the iron-containing particles, thus reducing, or avoiding, undesirable reactions between the sulfide-containing material and the iron-containing material during fabrication of an iron electrode in which the sulfide-containing material is an additive.

Large-scale electrical energy storage is an essential energy generation form to fill the gaps of solar and wind resources. Iron-based alkaline rechargeable batteries may be used in large-scale energy storage applications due to their low cost, robustness, and environmental-friendliness. However, the low charging efficiency and poor discharge rate capability of the iron electrodes can present challenges for widespread application of iron-based alkaline rechargeable batteries. For example, iron sulfide (FeS) is sparingly soluble in the alkaline electrolyte. Accordingly, with the passage of time, the sulfide ions are gradually lost from the iron electrode to the electrolyte. Moreover, most equipment may have leaking issues to various extents. In such instances, dissolved sulfide may then irreversibly oxidized to sulfite and sulfate at the positive electrode. The FeS is also electrochemically reduced during the charging process, accelerating the loss of sulfide from the electrode. A beneficial life span for the iron-based alkaline rechargeable batteries may be approximately 10 years or more. Continued loss of sulfide may reduce the cycle life and discharge rate capability of the iron electrode and reduce the life span of the iron electrode below the beneficial life span of approximately 10 years or more.

The solubility of the sulfide-containing material may be much less than that of iron (II) sulfide in an alkaline solution. For example, zinc sulfide (ZnS) may be at least 140 times lower than that of the baseline iron (II) sulfide in an alkaline solution. Due to its particularly low solubility as a reservoir for sulfide ion and excellent capacity retention during cycle life without any notable decay in capacity, zinc sulfide (ZnS) may be a desirable sulfide additive for improving performance of iron electrodes.

Additionally, or alternatively, the processing methods used to fabricate iron electrodes can affect bonding of iron particles and impact the performance of iron electrodes. Often, iron electrodes can yield high performance and are cost-effective when the iron particles are metallurgically bonded. To this end, high-temperature processing methods, like sintering or hot compaction, may be adopted for processing iron-containing particles to form iron electrodes. In this context, high-temperature shall be understood to include temperatures at which iron in iron-containing particles bonds in the solid state. For example, high temperature processing methods and/or environments referred to herein may include one or more processing methods and/or environments having temperatures of about 600° C. or greater, such as 600° C. to 800° C., about 800° C., about 800° C. or greater, 800° C. to 900° C., about 900° C., 600° C. to 900° C., about 900° C. or greater, 900° C. to 1000° C., about 1000° C., 600° C. to 1000° C., about 1000° C. or greater.

As an example, in the iron electrodes, when ZnS is selected as a sulfide-containing additive, iron-containing particles and ZnS particles may be processed together in high temperature processes to increase metallurgical bonding between iron in the iron-containing particles. However, these processes may lead to the evaporation of Zn from the iron electrodes via the reduction of ZnS by Fe via ZnS+Fe→FeS+Zn (g). This evaporation and deposition of Zn may lead to increased material costs and/or equipment problems. In some cases, this reduction reaction may yield approximately 10% loss of ZnS additive from the iron electrode during processing. As such, it is desirable to reduce, minimize, or prevent this reduction reaction of ZnS and Fe to the extent possible. More generally, it is desirable to reduce, minimize, or prevent reduction reactions of sulfide-containing material and iron, to the extent possible, to reduce loss of the sulfur-containing additive from the iron electrode during processing.

For the sake of clear and efficient description, elements with numbers having the same last two digits in the disclosure that follows shall be understood to be analogous to or interchangeable with one another, unless otherwise explicitly stated or made clear from the context and, therefore, are not described separately from one another, except to note difference or to emphasize certain features. Thus, for example, iron-containing particles 176 of a feedstock 175 and iron-containing particles 276 of a feedstock 275a, 275b, and 276c shall be understood to be analogous to or interchangeable with one another, unless otherwise specified or made clear from the context. Further, in the schematic representations of various feedstocks described herein, only a few particles are shown for the sake of clarity of depiction and it shall be appreciated that feedstock used to form any one or more of the iron electrodes described herein may include many more instances of particles than those shown in the figures.

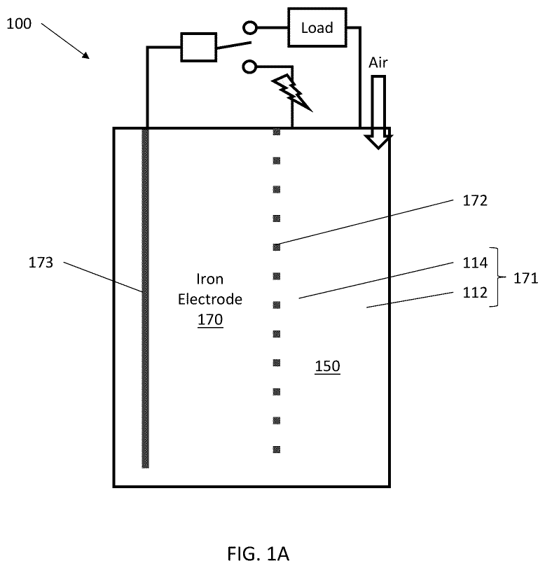

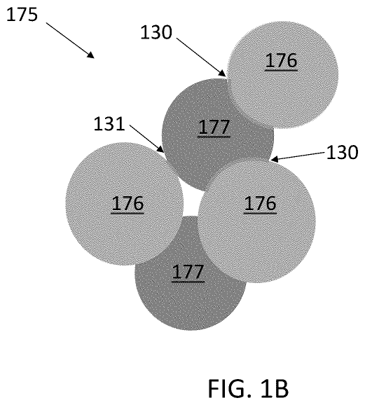

Referring now to FIG. 1A, an iron-air electrochemical cell 100 is an example of an electrochemical cell including an iron electrode. Unless otherwise specified or made clear from the context, various embodiments may be applicable to other types and/or configurations of electrochemical cells including iron electrodes. The iron-air electrochemical cell 100 may include an iron electrode 170, a split bifunctional positive electrode 171 including a discharge positive electrode 112 and a charge positive electrode 114. The iron electrode 170 may additionally, or alternatively, include a current collector 173 formed of a highly conductive material, such as steel, iron, nickel, etc.

Further, or instead, a dielectric separator 172 may be disposed between the charge positive electrode 114 and the iron electrode 170. The dielectric separator 172 may include a compression frame, a porous insulator, and/or a ribbed structure to facilitate bubble egress from the iron electrode 170. In some embodiments, the dielectric separator 172 may include a porous dielectric coating formed on the iron electrode 170 and/or on the charge positive electrode 114.

The iron electrode 170 and the charge positive electrode 114 may each be immersed in an electrolyte 150. A first side of the discharge positive electrode 112 may be exposed to the electrolyte 150 and an opposing second side of the discharge positive electrode 112 may be exposed to air and/or another source of oxygen.

During charging, the charge positive electrode 114 and the iron electrode 170 may be electrically connected to a power source, such that iron species of the iron electrode 170 may be reduced to form metallic iron. During discharging, the discharge positive electrode 112 and the iron electrode 170 may be electrically connected to a load, such that metallic iron of the iron electrode 170 may be oxidized to produce electricity.

The electrolyte 150 include an aqueous solution. In certain implementations, the electrolyte 150 may be an alkaline solution (pH>10), a near-neutral solution (10>pH>4), or an acidic solution (4>pH>0).

The charge positive electrode 114 may be permeable to the electrolyte 150. For example, the charge positive electrode 114 may include a porous metal sheet or mesh. In some embodiments, the charge positive electrode 114 may include a nickel mesh and/or a nickel-plated steel mesh. The charge positive electrode 114 may include an oxygen evolution reaction catalyst.

The discharge positive electrode 112 may be electrically conductive, and permeable to oxygen. The discharge positive electrode 112 may include a conductive gas diffusion electrode catalyst (e.g., carbon, manganese oxide, silver, platinum, nickel foam, a nickel mesh, etc.), and may also, or instead, include a hydrophobic material (e.g., polytetrafluoroethylene (PTFE)). For example, the discharge positive electrode 112 may include a hydrophilic region and a hydrophobic region. The hydrophobic region may be exposed to air and the hydrophilic region may be exposed to the electrolyte 150.

In certain implementations, the iron electrode 170 may include a porous iron-containing material. For example, the iron electrode 170 may include metallic iron and various iron compounds, such as iron oxides, hydroxides, sulfides, carbides, or combinations thereof. According to various embodiments, the iron electrode 170 may be formed from pelletized, briquetted, pressed, powdered, and/or sintered iron-containing compounds. Such iron-containing compounds may include one or more forms of iron, ranging from highly reduced (more metallic) iron to highly oxidized (more ionic) iron. In various embodiments, the iron electrode 170 may include sintered iron agglomerates having various shapes. In various embodiments, the iron electrode 170 may be formed by various manufacturing methods, for example any one or more of the methods described in U.S. Pat. App. Pub. 2022-0149359, published on May 12, 2022, and entitled “METHOD OF IRON ELECTRODE MANUFACTURE AND ARTICLES AND SYSTEMS THEREFROM,” the entire contents of which are incorporated herein by reference. In some embodiments described in U.S. Pat. App. Pub. 2022-0149359, a feedstock material for forming sintered iron electrodes may include atomized or sponge iron powders. For example, the iron electrode 170 may include metallurgically-bonded sponge iron particles, such as direct reduced iron (DRI) or other sponge iron powder particles. U.S. Pat. App. Pub. 2022-0149359 also describes various embodiments and provides specific examples of aspects of electrochemical cells, such as rechargeable batteries using iron negative electrodes, and design, manufacture, and processing features of electrochemical cells, such as rechargeable batteries using iron negative electrodes, with which various embodiments as described herein may be used and into which various embodiments as described herein may be incorporated. Additionally, U.S. Pat. App. Pub. 2022-0149359 gives examples of iron-containing materials, such as DRI, with which various embodiments as described herein may be used. Further, U.S. Pat. App. Pub. 2022-0149359 describes bulk energy storage systems, such as LODES systems, with which various embodiments as described herein may be used and into which various embodiments as described herein may be incorporated.

In some embodiments, multiple instances of the iron-air electrochemical cell 100 may be connected electrically in series to form a stack. Further, or instead, a plurality of instances of the iron-air electrochemical cell 100 may be connected electrically in parallel. Additionally, or alternatively, multiple instances of the iron-air electrochemical cells 100 may be connected in a combination of series and parallel electrical connections.

In various embodiments, one or more additives may be added to an iron-air electrochemical cell 100. In some embodiments, a sulfur-containing species such as a sulfide may be present in the form of one or more additives to the iron electrode 170. As one example, the sulfide-containing material added to the iron electrode 170 may include on or more iron sulfide (e.g., FeS, Fe₃S₄, Fe₂S₃, and/or other forms), tin sulfide (SnS), bismuth sulfide (Bi₂S₃), aluminum sulfide (Al₂S₃), antimony (III) sulfide (Sb₂S₃), antimony (V) sulfide (Sb₂S₅), manganese sulfide (MnS), iron disulfide (FeS₂), iron-copper sulfide, cadmium sulfide (CdS), silver sulfide (AgS), titanium disulfide (TiS₂), lead sulfide (PbS), nickel sulfide (NiS), antimony sulfide (Sb₂S₃), copper sulfide (CuS, Cu₂S), cobalt sulfide (CoS), tungsten sulfide (WS₂), molybdenum sulfide (MoS₂), manganese sulfide (MnS), sodium sulfide (Na₂S), nickel sulfide (Ni₃S₂), indium sulfide (In₂S₃), zinc sulfide (ZnS), or a combination thereof. In the iron electrode 170, reduction reaction of sulfide-containing additive by Fe may take place primarily in the solid state.

Referring now to FIG. 1B, a feedstock 175 for forming the iron electrode 170 may include iron-containing particles 176 and sulfide-containing particles 177. Unless otherwise, specified or made clear from the context, the iron-containing particles 176 shall be understood to be a first material, and the sulfide-containing particles 177 shall be understood to be a second material different from the first material. The iron-containing particles 176 and the sulfide-containing particles 177 may contact one another at contact points 130, 131, which may result in a reduction reaction between iron in the iron-containing particles 176 and sulfur in the sulfide-containing particles 177. For example, when the iron-containing particles 176 and the sulfide-containing particles 177 are processed at high temperatures for increasing the metallurgical bonding of iron in the iron-containing particles 176, there may be many instances of the contact points 130, 131 between the iron-containing particles 176 and the sulfide-containing particles 177 such that the reduction reaction between iron in the iron-containing particles 176 and sulfur in the sulfide-containing particles 177 may take place to a significant extent. In certain instances, the iron-containing particles 176 may partially overlap with the sulfide-containing particles 177 such that the contact points 130, 131 form an arc on the circumference of the iron-containing particles 176. Further, or instead, the contact points 130, 131 may be on a tangent line of the sulfide-containing particles 177 when the sulfide-containing particles 177 and respective instances of the iron-containing particles 176 are tangent to each other. The contact points 130, 131 are sources for the reduction reaction of sulfur in the sulfide-containing particles 177 by iron in the iron-containing particles 176, which leads the evaporation of metal from the iron electrode 170. In certain implementations, pressing the iron-containing particles 176 and the sulfide-containing particles 177 may increase the size (e.g., contact area) of the contact points 130, 131 between the iron-containing particles 176 and the sulfide-containing particles 177.

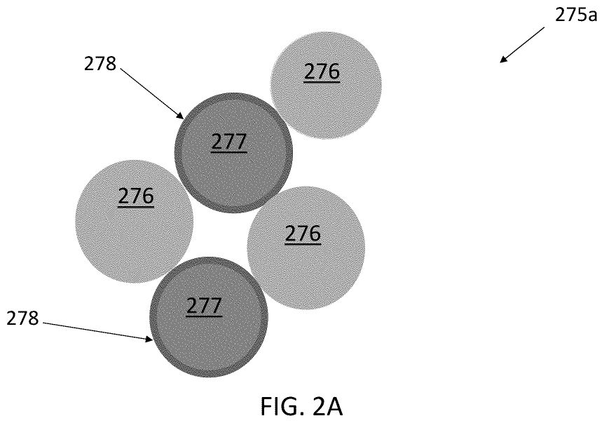

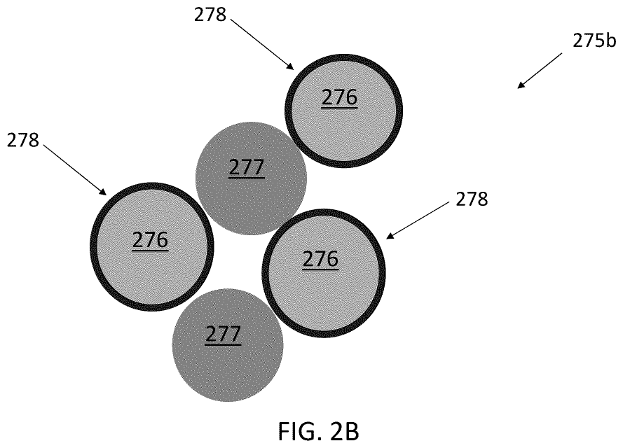

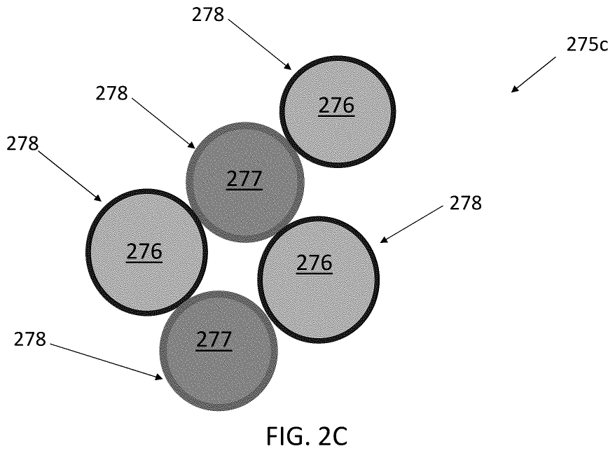

Referring now to FIG. 2A, a feedstock 275 for fabricating an iron electrode (e.g., the iron electrode 170 of the iron-air electrochemical cell 100 in FIG. 1A) may include iron-containing particles 276, sulfide-containing particles 277, and a barrier material 278. The iron-containing particles 276 may be a first material, the sulfide-containing particles 277 may be a second material different from the first material, and the of a second material different from the first material, and the barrier material 278 may be different from each of the first material and the second material. The barrier material 278 may at least partially physically separate the sulfide-containing particles 277 from the iron-containing particles 276, with the barrier material 278 maintaining the at least partial physical separation of the iron-containing particles 276 from the sulfide-containing particles 277 at temperatures at which iron in the iron-containing particles 276 bonds in the solid state. Thus, as compared to a feedstock without a barrier material and in which iron-containing particles and sulfide-containing particles are in contact with each other, the at least partial physical separation of the sulfide-containing particles 277 from the iron-containing particles 276 by the barrier material 278 may reduce and/or prevent the contact between the iron particles (e.g., 110) and ZnS particles (e.g., 120). In doing so, the barrier material 278 may significantly reduce the amount of reduction reactions between the second material of the sulfide-containing particles 277 and iron of the iron-containing particles 276 during manufacture of an iron electrode (e.g., the iron electrode 170 in FIG. 1A). In certain implementations, at least partially physically separating the iron-containing particles 276 from the sulfide-containing particles 277 using the barrier material 278 inhibit reactions mediated by evaporation-condensation through a similar mechanism to limit the ability of the reactant to reach the reaction site.

In certain implementations, the barrier material 278 may be a coating on the sulfide-containing particles 277 such that instances of contact and amount of contact between the iron-containing particles 276 and the sulfide-containing particles 277 may be significantly reduced and/or eliminated by the barrier material 278. In various instances, the barrier material 278 may partially or fully infiltrate the porosity of the sulfide-containing particles 277 on which the barrier material 278 is coated. Further, or instead, the barrier material 278 may be porous or nonporous. For example, the barrier material 278 may be porous or nonporous as a coating on the sulfide-containing particles 277. Still further, or instead, while the barrier material 278 is shown as enveloping the respective outer surfaces of the sulfide-containing particles 277, it shall be appreciated that this is for the sake of clarity of illustration other extents of coating by the barrier material 278 are additionally or alternatively possible. Thus, unless otherwise specified or made clear from the context, it shall be appreciated that the barrier material 278 may partially coat the respective outer surfaces of the sulfide-containing particles 277 in some implementations, without departing from the scope of the present disclosure. Some examples of partial coverage of the barrier material 278 on the respective outer surfaces of the sulfide-containing particles 277 is described in greater detail below.

The barrier material 278 may include, for example, at least one oxide (e.g., a refractory oxide) at least partially physically separating the iron-containing particles 276 from the sulfide-containing particles 277 in the feedstock 275a. The oxide may include alumina (Al₂O₃), magnesium oxide (MgO), calcium oxide (CaO), silica (SiO₂), zinc oxide (ZnO), zirconium oxide (ZrO₂), one or more an iron oxide, or a combination thereof. Further, or instead, the barrier material 278 may include glassy slags. Further, or instead, the barrier material 278 may include one or more carbides (e.g., a refractory carbide). For example, the one or more carbide may include silicon carbide (SiC), tungsten carbide (WC), hafnium carbide (HfC), zirconium carbide (ZrC), titanium carbide (TiC), iron carbide (FeC), or a combination thereof. Still further, or instead, the barrier material 278 may include one or more silicides (e.g., a refractory silicide). As an example, the one or more silicides may include molybdenum silicide (MoSi₂), one or more iron silicide, or a combination thereof. In some implementations, the barrier material 278 may include one or more sulfide-based materials, such as sulfide-based materials that exhibit reduced reaction tendencies in the presence of metallic iron at high temperatures associated with fabricating iron electrodes. Some examples of sulfide-based materials that may at least partially form the barrier material 278 include iron sulfide (FeS) (e.g., as the reaction product of reaction of ZnS+Fe), copper (I) sulfide (Cu₂S), tungsten disulfide (WS₂), or a combination thereof. Further, or instead, the barrier material 278 may include one or more carbon-based materials, such as carbon-based materials include graphite, amorphous carbon, soot, or a combination thereof. Additionally, or alternatively, the barrier material 278 may be soluble in an electrolyte (e.g., the electrolyte 150 in FIG. 1A) such that the barrier material 278 dissolves in the electrolyte and access of the electrolyte to the second material associated with the sulfide-containing particles 277 remains undisrupted. Examples of such soluble material that may form at least a portion of the barrier material 278 include alumina (Al₂O₃) and zinc oxide (ZnO).

The barrier material 278 coated on the sulfide-containing particles 277 may have an average thickness that maintains at least partial separation of the sulfide-containing particles 277 from the iron-containing particles 276 in the feedstock 275a, with the average thickness of the coating being variable- and, therefore, tunable-base on various factors, such as the technology used to apply the coating and/or the materials used. In some instances, the coating of the barrier material 278 may have an average thickness less than a mean particle size of the iron-containing particles 276, less than a mean particle size of the sulfide-containing particles 277, or both. As an example, the average thickness of the coating of the barrier material 278 may be less than 40% of at least one of the mean particle size of the iron-containing particles 276 or the mean particle side of the sulfide-containing particles. In certain implementations (e.g., in instances in which the coating of the barrier material 278 is applied using atomic layer deposition (ALD)), the coating of the barrier material 278 may have an average thickness of about 0.1 angstroms to about 10 nanometers.

In general, the first material of the iron-containing particles 276 may be any one or more of the iron-containing materials described herein as forming or at least partially forming and/or or formable into an iron electrode (e.g., the iron electrode 170 in FIG. 1A). Thus, unless otherwise specified or made clear from the context, the first material of the iron-containing particles 276 may be any one or more of the various different types of iron described in U.S. Pat. App. Pub. 2022-0149359. Thus, in some implementations, the iron-containing particles 276 may be porous. Further, or instead, the iron-containing particles 276 may include sponge iron powder. Additionally, or alternatively, the iron-containing particles 276 may include direct reduced iron (DRI) particles. Still further, or instead, the iron-containing particles 276 may include atomized iron powder. In certain instances, the iron-containing particles 276 may be in powder form in the feedstock 275a.

In general, the sulfide-containing particles 277 may have any one or more of various different form factors that facilitate handling the sulfide-containing particles 277 alone or in combination with the iron-containing particles 276 and/or with the barrier material 278 while providing a target amount of additive in the iron electrode (e.g., the iron electrode 170) fabricated from the feedstock 275a. As an example, the sulfide-containing particles 277 may have a mean particle side from 1 micron to 1000 microns. Further, or instead, the sulfide-containing particles may in powder form, as may be useful for mixing the sulfide-containing particles 277 with the iron-containing particles 276 and/or the barrier material 278 to form the feedstock 275a according to any one or more of the various different techniques described herein.

While the barrier material 278 has been described as being coated on the sulfide-containing particles 277, it shall be appreciated that the barrier material 278 may be additionally, or alternatively, coated on other components of the feedstock 275a. For example, referring now to FIG. 2B, the barrier material 278 may be coated on the iron-containing particles 276 in a feedstock 275b. As another example, referring now to FIG. 2C, the barrier material 278 may be coated on the sulfide-containing particles 277 and on the iron-containing particles 276 in the feedstock 275c. Unless otherwise specified or made clear from the context, the feedstock 275a (FIG. 2A), the feedstock 275b (FIG. 2B), and the feedstock (FIG. 2C) shall be understood to be identical to one another, except with respect to the position of the coating of the barrier material 278. Thus, for the sake of clear and efficient description, features of the feedstock 275b (FIG. 2B) and the feedstock 275c (FIG. 2C) are not described separately.

While the barrier material 278 has been described as enveloping the sulfide-containing particles 277 (FIGS. 2A and 2C) and/or enveloping the iron-containing particles 276 (FIGS. 2B and 2C), it shall be appreciated that the barrier material 278 may cover only portions of the respective surfaces of material in the feedstock. In this context, partial coverage of a barrier material on iron-containing particles and/or on sulfide-containing particles may include spots of coverage (e.g., such that the barrier material does not form a coating) and/or a coating of the barrier material, with the coating being discontinuous such that the coating defines one or more gaps on the respective outer surfaces of the iron-containing particles, on the respective outer surfaces of the sulfide-containing particles, or a combination thereof.

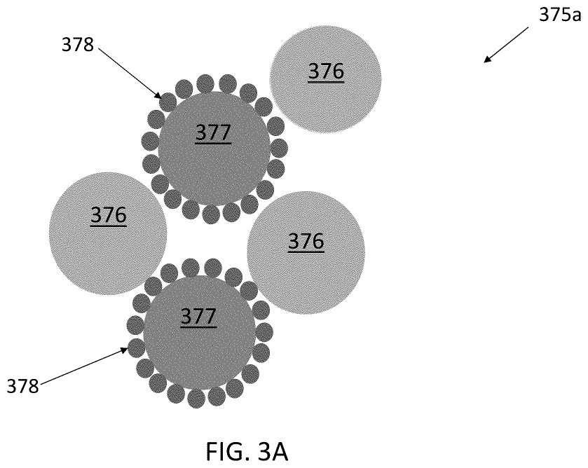

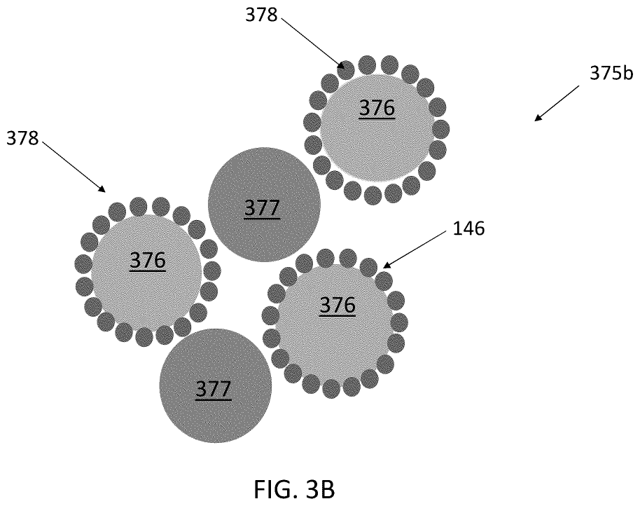

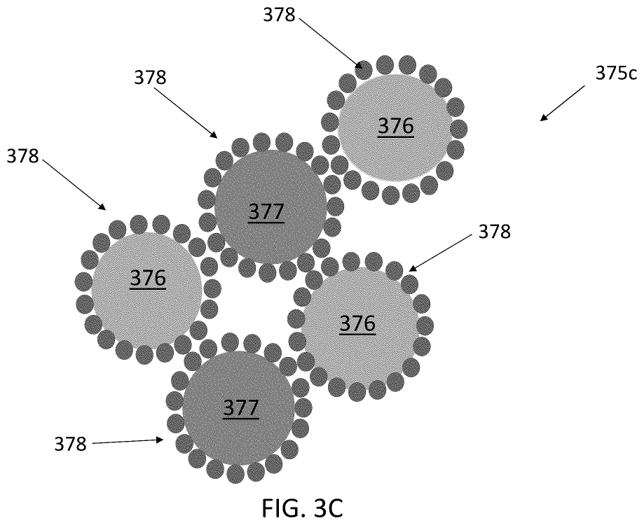

For example, referring now to FIG. 3A, a feedstock 375a may include iron-containing particles 376, sulfide-containing particles 377, and a barrier material 378. The barrier material 378 may partially cover the respective outer surfaces of the sulfide-containing particles 377 to act as a spacer between the iron-containing particles 376 and the sulfide-containing particles 377 in the feedstock 375a, thus reducing the likelihood that the iron-containing particles 376 and the sulfide-containing particles 377 may contact each other, in turn reducing the likelihood of undesirable reduction reactions between the iron-containing particles 376 and the sulfide-containing particles 377. Further, or instead, partial coverage of the barrier material 378 may require less of the barrier material 378 as compared to application of a barrier material as a full coating enveloping particles.

As another example, referring now to FIG. 3B, the barrier material 378 may partially cover the respective outer surfaces of the iron-containing particles 376 to act as a spacer between the iron-containing particles 376 and the sulfide-containing particles 377 in the feedstock 375b. Such spacing may reduce the likelihood of contact between the iron-containing particles 376 and the sulfide-containing particles 377 and, in turn, reduce the likelihood of undesirable reduction reactions between the iron-containing particles 376 and the sulfide-containing particles 377. With the barrier material 378 partially covering the iron-containing particles 376, efficient use may be made of the barrier material 378 as compared to the application of the barrier material 378 in a full coating to envelop particles.

As yet another example, referring now to FIG. 3C, the barrier material 378 may partially cover the respective outer surfaces of the iron-containing particles 376 and the respective outer surfaces of the sulfide-containing particles 377 in a feedstock 375c. The partial coverage of the barrier material 378 may act as a spacer between the iron-containing particles 376 and the sulfide-containing particles 377 to reduce the likelihood of contact between these particles, thus, reducing the likelihood of undesirable reduction reaction between the iron-containing particles 376 and the sulfide-containing particles 377.

While barrier materials have been described as fully and/or partially covering sulfide-containing particles and/or iron-containing particles, it shall be appreciated that other placements of the barrier materials relative to the sulfide-containing particles and/or the iron-containing particles are additionally, or alternatively, possible. For example, while the barrier material coated on the sulfide-containing particles may be flowable relative to the iron-containing particles in the feedstock and the barrier material coated on the iron-containing particles may be flowable relative to the sulfide-containing particles in the feedstock, the barrier material of the feedstock may be flowable relative to the sulfide-containing particles and relative to the iron-containing particles. That is, in some instances, the sulfide-containing particles and the iron-containing particles in the feedstock may be uncoated by the barrier material in the feedstock and positioning of the barrier material between the iron-containing particles and the sulfide-containing particles may reduce, or even eliminate, contact between the iron-containing particles the sulfide-containing particles.

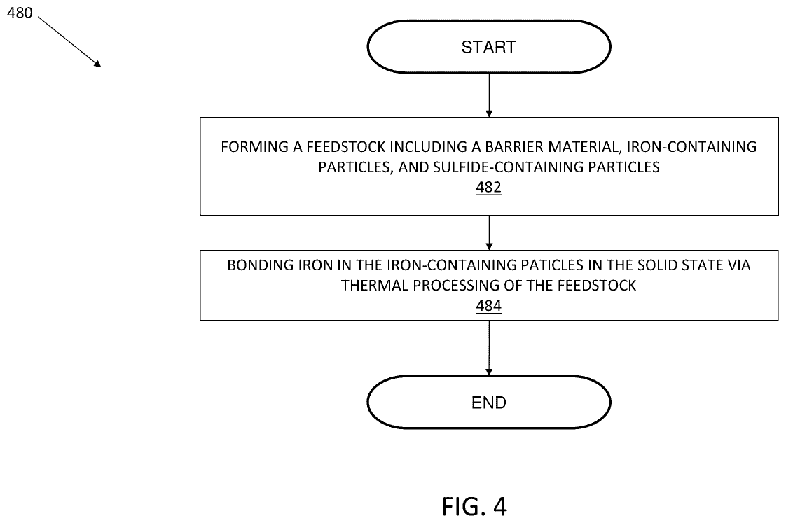

FIG. 4 is a flowchart of an exemplary method 480 of fabricating an iron electrode for an iron-air electrochemical cell. Unless otherwise specified or made clear from the context, the exemplary method 480 may be carried out to fabricate any one or more of the various different iron electrodes (e.g., the iron electrode 180 in FIG. 1A) described herein using any one or more of the various different feedstocks (e.g., the feedstock 275a in FIG. 2A, the feedstock 275b in FIG. 2B, the feedstock 275c in FIG. 2C, the feedstock 375a in FIG. 3A, the feedstock 375b in FIG. 3B, and/or the feedstock 375c in FIG. 3C).

As shown in step 482, the exemplary method 480 may include forming a feedstock including a barrier material, iron-containing particles of a first material, and sulfide-containing particles of a second material, with the barrier material at least partially physically separating the sulfide-containing particles from the iron-containing particles in the feedstock, and the first material, the second material, and the barrier material each differing from one another. Unless otherwise specified or made clear from the context, the barrier material may include any one or more of the various, different barrier materials described herein. Similarly, unless a contrary intent is expressly stated or made clear from the context, the iron-containing particles and the sulfide-containing particles may include any one or more of the various, different types of iron-containing particles and sulfide-containing particles, respectively, described herein.

In various embodiments, the barrier material may be coated on the sulfur-containing particles and/or on the iron-containing particles to maintain at least partial physical spacing between the sulfur-containing particles and the iron-containing particles. For example, the barrier material may be applied to the sulfur-containing particles and/or to the iron-containing particles by physical abrasion (e.g. by a milling process), atomic layer deposition (ALD), chemical vapor deposition (CVD), coating the iron-containing particles and/or the sulfur-containing particles in a slurry, or any other technique for applying a coating of the barrier material to the iron-containing particles and/or to the sulfur-containing particles. As another example, powder atomic layer deposition may be used to coat the barrier material onto the sulfur-containing particles and/or onto the iron-containing particles. The ALD technique may produce a monolayer of coating that covers all topographical contours of the surface of the sulfur-containing particles and/or of the iron-containing particles, as the case may be. Compared to other thin film fabrication techniques, such as chemical vapor deposition (CVD), ALD may facilitate forming the barrier material as a coating having a uniform thickness on the contours of the outer surfaces of the sulfur-containing particles and/or of the iron-containing particles.

In various embodiments, barrier material may be formed in-situ by reaction of impurities in the sulfide-containing particles to form any of the barrier material as a coating on the sulfide-containing particles, as discussed herein. For example, the sulfide-containing particles may be reacted with the iron-containing particles to form the barrier material including iron sulfide (FeS). In various embodiments, chemical precipitation may be used to form the barrier material as a coating on the sulfide-containing particles and/or the iron-containing particles. In some embodiments, the barrier material may be coated on the sulfur-containing particles by oxidizing the second material of the sulfur-containing particles so that sulfur-containing particles are covered by an oxide layer. The oxidation may take place, for example, in a fluidized bed or similar reactor, such that the oxide covering is uniform in thickness. In the case of carbon-based materials, the barrier material may be formed by pyrolysis of carbon-based materials on the respective surfaces of the iron-containing particles and/or the respective surfaces of the sulfide-containing particles.

The barrier layer may be coated on the iron-containing particles and/or on the sulfur-containing particles to form the feedstock by a solid phase coating process, such as physically abrading the barrier material against the material to be coating (e.g. by a milling process), a gas-phase coating process such as ALD or CVD, or a liquid phase coating process such as coating the powder particles with a slurry, or any other technique of applying a coating of the barrier material to the iron-containing particles and/or to the sulfide-containing particles. As another example, powder atomic layer deposition may be used to coat the barrier material on the sulfide-containing particles and/or on the iron-containing particles. In various embodiments, the barrier material may be coated on the sulfide-containing particles in-situ by reaction of impurities in the sulfide-containing particles. As an example of in-situ reaction of impurities, an aluminum impurity in the sulfide-containing particles (e.g., the second material of the sulfide-containing particles is ZnS) may be allowed to oxidize to an Al₂O₃ coating on the sulfide-containing particles, thus reducing the likelihood of reduction of the second material of the sulfide-containing particles. In various embodiments, chemical precipitation may be used to form a coating of the barrier material on the sulfide-containing particles and/or on the iron-containing particles. In some embodiments, the barrier material may be formed by oxidizing the sulfide-containing particles so that the sulfide-containing particles may be covered by a layer of the oxide (e.g., the second material of the sulfur-containing particles may be ZnS such that the layer of oxide is ZnO). The oxidation may take place in a fluidized bed or similar reactor design to create uniform reactions so that the resulting coating of the barrier material is uniform in thickness and between particles.

In certain implementations, crating the coating of the barrier material to form the feedstock may include at least partially covering the iron-containing particles, the sulfide-containing particles, or a combination thereof with a precursor material and processing the precursor material into the barrier material. For example, the precursor material may include a carbon-based material, and processing the precursor material into the barrier material includes pyrolyzing the carbon-based material.

In some implementations, forming the feedstock may include forming the sulfide-containing particles from a metallic precursor and a sulfur precursor such that the sulfide-containing particles are nanoparticles. As an example, the metallic precursor is zinc carboxylate. Further, or instead, the sulfur precursor may be sodium sulfide (Na₂S), thiourca, or a combination thereof. Formation of the metallic precursor and the sulfur precursor into the sulfide-containing particles may be carried out, for example, in a pressure vessel containing water at 125° C. Additionally, or alternatively, formation of the metallic precursor and the sulfur precursor into the sulfide-containing particles may be carried out in an organic solvent. Continuing with this example, the coating of the barrier material may include iron oxide coated on the iron-containing particles.

As shown in step 484, the exemplary method 480 may include bonding iron in the iron-containing particles in the solid state via thermal processing as the barrier material at least partially maintains physical separation of the iron-containing particles from the sulfide-containing particles. As compared to carrying out such thermal processing using a feedstock without the barrier material, the physical separation maintained by the barrier material during the thermal processing may reduce the likelihood of contact between the iron-containing particles and the sulfide-containing particles at the elevated temperatures of the thermal processing, thus reducing the likelihood of undesirable reduction reactions between iron in the iron-containing particles and sulfur in the sulfide-containing particles. In certain implementations, the barrier layer may remain intact at the elevated temperatures of the thermal processing used to bond iron in the iron-containing particles in the solid state. For example, the barrier layer may be inert at the elevated temperatures of the thermal processing.

In general, bonding iron of the iron-containing particles in the solid state via thermal processing may be carried out at temperatures at which iron in the iron-containing particles bonds in the solid state. Such thermal processing may include one or more types of treatments, such as sintering and/or hot compaction, for promoting metallurgical bonding of the iron. Examples of thermal processing techniques that may be additionally, or alternatively, used to thermally process the feedstock are described in U.S. Pat. App. Pub. 2022-0149359. In various embodiments, the temperature for thermal processing of the feedstock may range from about 650° C. to about 1200° C. For example, the temperature for processing the powder particles may range from about 650° C. to about 850° C., from about 850° C. to about 900° C., from about 900° C. to about 1000° C., from about 1000° C. to about 1100° C., or from about 1100° C. to about 1200° C. Further, or instead, bonding iron of the iron-containing particles via thermal processing may be carried out in a gaseous environment or in a vacuum. The gas suitable for processing may include, but is not limited to, hydrogen, carbon monoxide gas, or inert gas such as nitrogen, or argon, etc. The reducing or inert gas may help reduce the likelihood of oxidation of the iron-containing particles and/or the sulfide-containing particles during the high temperature processing.

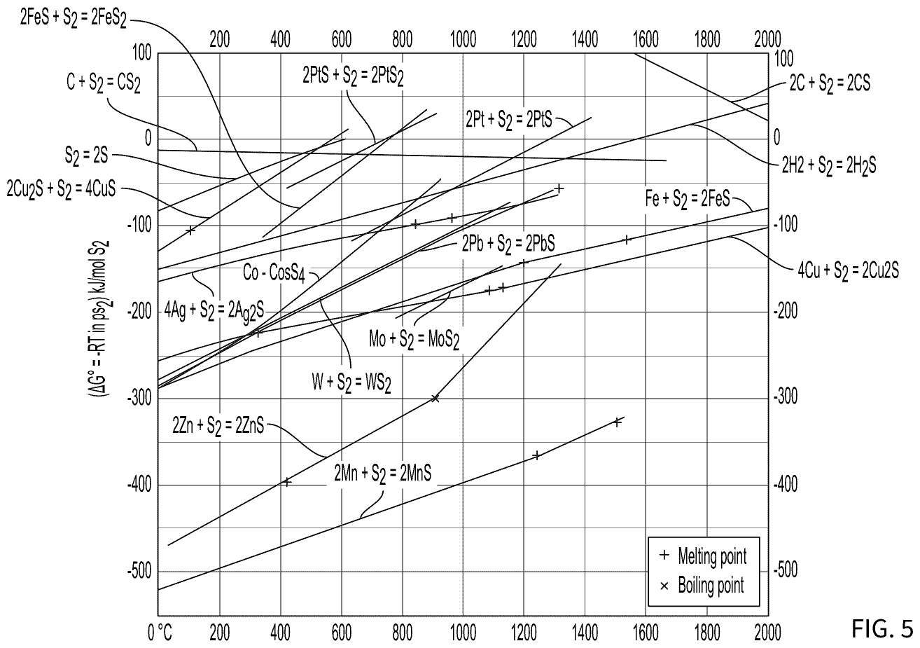

FIG. 5 is an Ellingham diagram illustrating stability of various sulfides through comparing free energy changes during formation of the various sulfides according to various embodiments of the present disclosure.

As shown in FIG. 5, the Gibbs free energy changes for various sulfides demonstrates the stability of compounds with temperature. In this diagram, Cu₂S is stable relative to FeS, and MnS is stable relative to FeS. Therefore, both Cu₂S and FeS can be alternative materials for the barrier material.

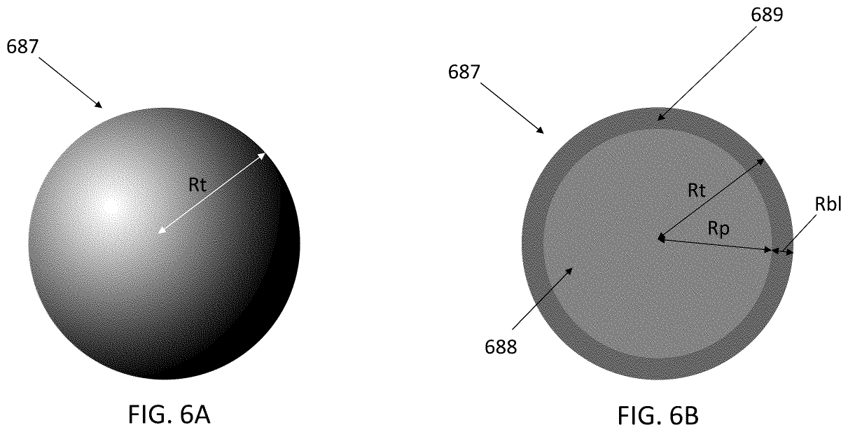

Referring now to FIGS. 6A and 6B, is a fully coated particle 687 including a core particle 688 and a coating 689 of a barrier material enveloping the core particle 688. In the discussion that follows, all references to radiuses and thicknesses shall be understood to include be average radiuses and thicknesses, thus, encompassing shapes that are geometrically spherical as well as shapes that deviate from such a geometric ideal.

The fully coated particle 687 may be any one or more of the sulfide-containing particles and/or the iron-containing particles described herein as being coated by the barrier material, with such coating enveloping the particles, and the barrier material may be any one or more of the various different types of barrier material described herein. The coating 689 of the fully coated particle 687 be continuous such that the radius (Rt) of the fully coated particle 687 is equal to the radius (Rp) of the core particle 688 plus the thickness (Rbl) of the coating 689. In various embodiments, the thickness of the coating 689 of the barrier material around the fully coated particle 687 may be smaller in thickness than the radius (Rp) of the core particle 688 (e.g., Rbl may be less than Rp). The effective coating thickness (e.g., Rbl) may vary based on various factors, such as the coating technology employed and materials used.

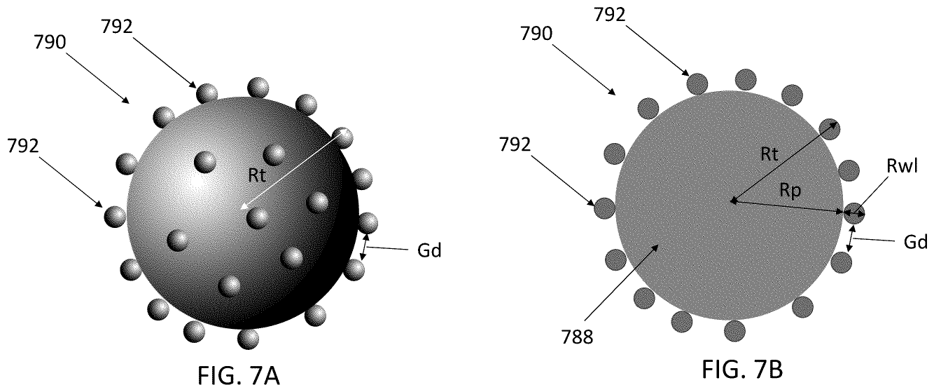

Referring now to FIGS. 7A and 7B, a partially coated particle 790 may include a core particle 788 and barrier material particles 792 in accordance with various embodiments, and FIG. 7B is a cross-section of such particle 602. In the discussion that follows, all references to radiuses and thicknesses shall be understood to include be average radiuses and thicknesses, thus, encompassing shapes that are geometrically spherical as well as shapes that deviate from such a geometric ideal.

The partially coated particle 790 may be any one or more of the sulfide-containing particles and/or the iron-containing particles described herein as being partially covered by the barrier material, and the barrier material may be any one or more of the various different types of barrier material described herein. The partially coated particle 790 may have a radius (Rt) equal to the radius (Rp) of the core particle plus the mean particle size (Rwl) of the barrier material particles 792. The barrier material particles 792 may be spaced apart from one another by various distances Gd. The spacing between the barrier material particles 792 may be uniform or may be non-uniform. In various embodiments, the mean particle size (Rwl) of the barrier material particles 792 may be less than the radius of the core particle 788 on which the barrier material particles 792 are coated (e.g., Rwl may be less than Rp). The mean particle size (Rwl) may correspond to the mean thickness of the coating of the barrier material particles 792 on the core particle 788 and, further, or instead, may be varied based on various factors such as the coating technology employed and materials used.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the described embodiment. Further, any step of any embodiment described herein can be used in any other embodiment. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the following claims and the principles and novel features disclosed herein.

1. A feedstock for fabricating an iron electrode of an electrochemical cell, the feedstock comprising:
iron-containing particles of a first material;
sulfide-containing particles of a second material different from the first material; and
a barrier material different from each of the first material and the second material, the barrier material at least partially physically separating the sulfide-containing particles from the iron-containing particles, the at least partial physical separation of the iron-containing particles from the sulfide-containing particles maintainable by the barrier material at temperatures at which iron in the iron-containing particles bonds in the solid state.

2-16. (canceled)

17. The feedstock of claim 1, wherein the barrier material is a coating on the iron-containing particles, on the sulfide-containing particles, or on a combination thereof.

18-31. (canceled)

32. A method of fabricating an iron electrode for an electrochemical cell, the method comprising:
forming a feedstock including a barrier material, iron-containing particles of a first material, and sulfide-containing particles of a second material, the barrier material at least partially physically separating the sulfide-containing particles from the iron-containing particles in the feedstock, and the first material, the second material, and the barrier material each differing from one another; and
bonding iron in the iron-containing particles in the solid state via thermal processing as the barrier material at least partially maintains physical separation of the iron-containing particles from the sulfide-containing particles.

33. The method of claim 32, wherein forming the feedstock includes creating a coating of the barrier material on the iron-containing particles, on the sulfide-containing particles, or on a combination thereof.

34. The method of claim 33, wherein creating the coating includes a solid-phase coating process.

35. The method of claim 34, wherein the solid-phase coating process includes physically abrading the barrier material against the iron-containing particles and/or against the sulfide-containing particles.

36. The method of claim 33, wherein creating the coating includes a gas-phase coating process.

37-38. (canceled)

39. The method of claim 33, wherein creating the coating includes a liquid-phase coating process.

40. (canceled)

41. The method of claim 33, wherein creating the coating of the barrier material includes chemical precipitation of the barrier material from a solution.

42. The method of claim 33, wherein creating the coating of the barrier material includes at least partially covering the iron-containing particles, the sulfide-containing particles, or a combination thereof with a precursor material and processing the precursor material into the barrier material.

43. (canceled)

44. The method of claim 33, wherein forming the feedstock includes forming the sulfide-containing particles from a metallic precursor and a sulfur precursor such that the sulfide-containing particles are nanoparticles.

45. The method of claim 44, wherein the metallic precursor is zinc carboxylate.

46-47. (canceled)

48. The method of claim 44, wherein formation of the metallic precursor and the sulfur precursor into the sulfide-containing particles is carried out in an organic solvent.

49. (canceled)

50. The method of claim 33, wherein the barrier material includes an oxide and creating the coating of the barrier material includes oxidizing the sulfide-containing particles to form a layer of oxide on the sulfide-containing particles.

51-52. (canceled)

53. The method of claim 32, wherein forming the feedstock includes producing the barrier material from one or more impurities in the sulfide-containing particles.

54. (canceled)

55. The method of claim 32, wherein the barrier material includes iron sulfide (FeS), and forming the feedstock includes reacting sulfide-containing particles with iron of the iron-containing particles to form FeS of the barrier material.

56. (canceled)

57. The method of claim 32, wherein bonding iron in the iron-containing particles in the solid state via thermal processing is carried out at temperatures greater than 600° C. and less than about 1200° C.

58. The method of claim 32, wherein bonding iron in the iron-containing particles in the solid state via thermal processing is carried out in a gaseous environment including hydrogen, carbon monoxide gas, or a combination thereof.

59. (canceled)

60. The method of claim 32, wherein bonding iron in the iron-containing particles in the solid state via thermal processing is carried out in a gaseous environment including one or more inert gases.

61. (canceled)

62. The method of claim 32, wherein bonding iron in the iron-containing particles in the solid state via thermal processing is carried out in a vacuum environment.

63. (canceled)
